(19) United States
(12) Patent Application Publication
(10) Pub. No.: US 2009/0057638 A1
(43) Pub. Date: Mar. 5, 2009

(54) Plastic or composite slat with wooden appearance

(76) Inventor: Patrick R. Hoggan, North Logan, UT (US)

Correspondence Address: Thompson E. Fehr;Goldenwest Corporate Center, Suite 300, 5025 Adams Avenue, Ogden, UT, 84403, US

(21) Appl. No.: 11/700,994

(22) Filed: Feb. 1, 2007

(51) Int. Cl. E04H 17/06; B29C 47/08

(52) U.S. Cl. 256/34; 264/129

(57) ABSTRACT

A plastic or composite slat with wooden appearance, to be inserted into chain link fences, having three or more longitudinal projections on at least one face of the slat. A majority of the projections on a face of the slat having projections are the same color as the slat, and a minority of the projections on such a face have a color different from that of the slat. The slat and a majority of the projections on each face are extruded; the minority of the projections on each face are either co-extruded from an extrudable material having a color different from the color of the slat or are painted with a color different from the color of the slat. Optionally, the longitudinal projections can be replaced with longitudinal depressions.

### BACKGROUND OF THE INVENTION

1. Field of the Invention

This invention relates to slats which are inserted into chain link fences in order to increase privacy and which are made of extrudable plastic or an extrudable composite material, but have a wooden appearance.

2. Description of the Related Art

A variety of patents have been granted for creating a wood grain pattern.

In the process of creating plastic siding panels with separate shingle appearance that is the subject of U.S. Pat. No. 7,008,213 a sheet of plastic material is vacuum formed into mold plate cavities “. . . having a wood grain surface texture corresponding to the desired wood grain appearance on the corresponding shingle . . . .”

Multiple paint transfers by a series of printing rollers having a wood grain pattern create the wood grain design on the polyvinyl chloride/wood composite of U.S. Pat. No. 6,844,049. And the slatwall (for holding displays) of U.S. Pat. No. 5,899,344 is extruded as a base foam core and, optionally, has a co-extruded, thin decorative coating on the base foam core. Also, rather than the co-extrusion, after the base foam core has been extruded, “. . . hot stamped layers are disposed on a carrier film, and are applied to the extruded slatwall surface by applying heat and pressure to separate the layers from the carrier film to the slatwall surface. The hot stamped layers can represent any pattern or material (e.g., woods, solid colors, stones, abstract patterns, fibers, metals, etc.). The original patterns to be hot stamped are photographed and then reverse acid etched onto the printing roller printing the hot stamped film.”

The viewable surfaces of the shutter panels in U.S. Pat. No. 5,060,442 are “. . . embossed so as to simulate a woodgrain appearance.”

Also involving embossing is the rather complex process of U.S. Pat. No. 5,203,941. A wood grain printed coating is placed on a plastic siding panel by forming a matte release layer on a continuous, thin, flexible carrier sheet; forming a decorative coating on the outer surface of the hardened matte to create a transfer laminate; extruding a plastic sheet; overlaying the transfer laminate on the extruded sheet with the decorative coating thereof facing toward the extruded sheet; applying pressure to the transfer laminate and to the extruded sheet from an embossing roll to transfer the decorative coating to the extruded sheet and to emboss a three-dimensional impression into the decorative coating; and releasing the carrier sheet from the embossed decorative coating.

In order to provide a deeper wood grain pattern, the process of U.S. Pat. No. 5,869,138 grinding a synthetic board comprising wood meal, to form a large number of wound stripes in one direction on the entire surface of at least one side of the board, applying a colorant on the surface on which the wound stripes are formed, which colorant permeates into the wood meal; then grinding and abrading the entire surface of the board except a recess pigment layer created by the colorant in the meal of the wound stripes; and printing a wooden grain pattern on the abraded surface.

A simpler process involving cutting synthetic lumber is the subject of U.S. Pat. No. 5,271,699. According to lines 49 through 52 in that patent, “The wood grain simulation pattern is comprised of a plurality of short slits . . . cut within the surface . . . [of the synthetic lumber] so as to displace the material to form short peaks.”

For the vertical plastic planks of the privacy fence in U.S. Pat. No. 5,529,289, to simulate weathered wood and stiffen the planks, “. . . a wave form . . . may be used . . . fine striations . . . [or] corrugations may be used. Alternatively, a simulated wood grain appearance may be rolled or embossed onto the plastic material after extrusion.”

And U.S. Pat. No. 5,899,239, in lines 7 through 10 of column 1 and 7 through 16 as well as 38 through 41 of column 4, explains a process for making “elongated tubular plastic fencing components, e.g., posts, pickets and rails . . . ”: “In the preferred embodiment, the process begins with the extrusion of a monolithic substantially planar sheet of plastic material 19 out of a sheet die 21. Sheet 19 may comprise one or more layers. Sheet 19 may, e.g., comprise a separate capstock layer and substrate layer supplied to sheet die 21 from separate extruders 23, 25 at approximately 400° F. Additionally, a third extruder 27 may be used to introduce a color streaking material, in order to provide a natural wood-simulating color variegation . . . . If desired, a surface texture pattern (e.g., simulated wood grain) may be embossed into the capstock by rolls 29, or by another set of rolls.”

None of the preceding, however, involve a slat for a chain link fence wherein the slat is given a wood grain appearance by having on at least one face longitudinal projections or depressions, preferably non-uniformly sized but preferably uniformly spaced (including having no space between consecutive projections or depressions) and wherein (a) a minority of the projections are either painted with a color different from that of the majority of projections or comprised of co-extruded material having a different color from that of the majority of projections or (b) a minority of the depressions are either painted with a color different from that of the majority of depressions or filled, at least partially, with co-extruded material having a different color from that of the majority of depressions.

### BRIEF SUMMARY OF THE INVENTION

As suggested by the preceding, the present invention comprises a slat for a chain link fence and the process for making the slat.

The slat is given a wood grain appearance by having on at least one face longitudinal projections or depressions, preferably non-uniformly sized but preferably uniformly spaced (including having no space between consecutive projections or depressions) and wherein (a) a minority of the projections are either painted with a color different from that of the majority of projections or comprised of co-extruded material (extrudable plastic or an extrudable composite) having a different color from that of the majority of projections or (b) a minority of the depressions are either painted with a color different from that of the majority of depressions or filled, at least partially, with co-extruded material having a different color from that of the majority of depressions.

Neither the projections nor the depressions need necessarily run the full length of the slat. And the slat may have faces spatially separated from one another or may be thin and solid (herein termed a single-wall slat).

### BRIEF DESCRIPTION OF THE SEVERAL VIEWS OF THE DRAWING

FIG. 1 shows a cross section of a slat having non-uniformly sized projections on a face with no space between the projections.

FIG. 2 displays a cross section of a slat having uniformly sized, non-uniformly spaced projections on both faces.

FIG. 3 depicts a cross section of a single-wall slat having non-uniformly sized depressions on a face with no space between the depressions.

FIG. 4 illustrates a cross section of a single-wall wall slat having uniformly sized, non-uniformly spaced depressions on both faces.

### DETAILED DESCRIPTION OF THE INVENTION

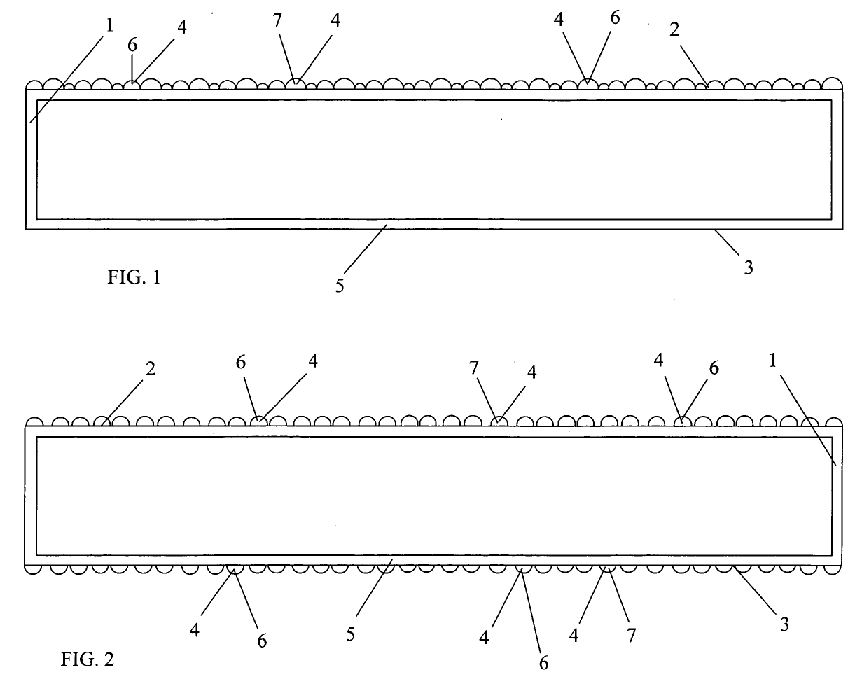

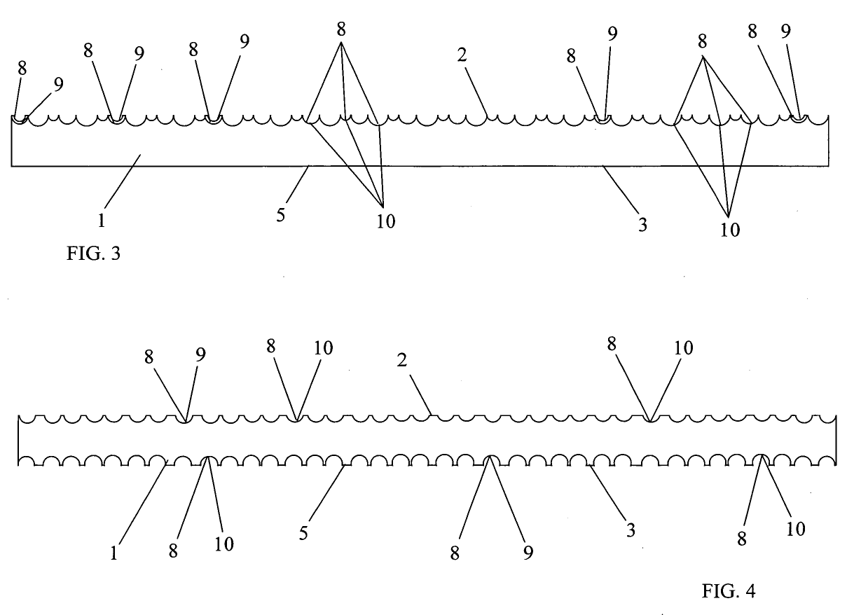

The Plastic or Composite Slat with Wooden Appearance of the present invention comprises a slat 1, which, as indicated above, may have faces 2, 3 spatially separated from one another, as illustrated in FIG. 1 and FIG. 2, or may be a single-wall slat, as shown in FIG. 3 and FIG. 4.

The slat 1 is composed of an extrudable material (extrudable plastic or an extrudable composite) but, preferably, of high-density polyethylene (HDPE).

In the preferred embodiment two or more longitudinal projections 4 have been formed on at least one face 2, 3 and, preferably, on both faces 2, 3. The projections 4 need not necessarily, but preferably do, run the full length 5 of the slat 1. The projections 4 are composed of an extrudable material (extrudable plastic or an extrudable composite); and, preferably, the projections 4 are composed of the same extrudable material as the slat 1. The exact shape of the projections 4 is not critical.

The slat 1 and the majority of the longitudinal projections 4 (designated the majority projections 6) are extruded. The minority of the projections 4 (designated the minority projections 7) are either extruded and painted with a color different from that of the majority of projections 4 or comprised of co-extruded material (extrudable plastic or an extrudable composite) having a different color from that of the majority projections 6. Preferably, at least eight, and most preferably precisely eight, percent of the face 2, 3 is covered with the minority projections 7. Optionally, minority projections 7 need not all be the same color as long as the color of each minority projection 7 differs from the color of the majority projections 6. Preferably, the color of the majority projections 6 is the same as the color of the slat 1.

Preferably, the size of the longitudinal projections 4 differs among the projections 4, i.e., herein the longitudinal projections 4 are termed as having a non-uniform size. Also preferably, the space between all consecutive projections 4 is the same (which is meant herein also to include the situation where all consecutive projections 4 are adjacent to one another), i.e., herein the space between longitudinal projections 4 is termed as being uniform.

Optionally, the longitudinal projections 4 can be replaced with longitudinal depressions 8, as depicted in FIG. 3 and FIG. 4. Preferences for spacing and size shall be the same as discussed for the longitudinal projections 4. Similarly the depressions 8 need not necessarily, but preferably do, run the full length 5 of the slat 1. The exact shape of the depressions 8 is not critical.

The slat 1 is extruded to contain the longitudinal depressions 8. A minority of the depressions 8 (designated the minority depressions 9) are either painted with a color different from that of the majority of depressions 8 or coated with co-extruded material (extrudable plastic or an extrudable composite) having a different color from that of the majority of the depressions 8 (designated the majority depressions 10). A given depression 8 can either be partially or completely filled with the co-extruded matrial. Preferably, at least eight, and most preferably precisely eight, percent of the face 2, 3 is covered with the minority depressions 9. Optionally, minority depressions 9 need not all be the same color as long as the color of each minority depression 9 differs from the color of the majority depressions 10. And, preferably, the color of the majority projections 10 is the same as the color of the slat 1.

Again, the slat 1 is composed of extrudable material (extrudable plastic or an extrudable composite), and the minority depressions 9 are preferably coated with the same material that composes the slat 1.

As used herein, the term “preferable” or “preferably” means that a specified element or technique is more acceptable than another but not that such specified element or technique is a necessity.

I claim:

1. A slat with a wood grain appearance for a chain link fence, which comprises:
a slat having two faces and being composed of an extrudable material; and
two or more longitudinal projections formed on at least one face of said slat, and composed of an extrudable material.

2. The slat with a wood grain appearance for a chain link fence as recited in claim 1, wherein:
a majority of said longitudinal projections are extruded and have a color; and
a minority of said longitudinal projections on each face having longitudinal projections are co-extruded to have a different color from that of the majority of said longitudinal projections.

3. The slat with a wood grain appearance for a chain link fence as recited in claim 2, wherein:
said longitudinal projections have a uniform size.

4. The slat with a wood grain appearance for a chain link fence as recited in claim 3, wherein:
the space between said longitudinal projections is uniform.

5. The slat with a wood grain appearance for a chain link fence as recited in claim 3, wherein:
the space between said longitudinal projections is non-uniform.

6. The slat with a wood grain appearance for a chain link fence as recited in claim 2, wherein:
said longitudinal projections have a non-uniform size.

7. The slat with a wood grain appearance for a chain link fence as recited in claim 6, wherein:
the space between said longitudinal projections is uniform.

8. The slat with a wood grain appearance for a chain link fence as recited in claim 6, wherein:
the space between said longitudinal projections is non-uniform.

9. The slat with a wood grain appearance for a chain link fence as recited in claim 1, wherein:
said longitudinal projections are extruded and have a color; and
a minority of said longitudinal projections on each face having longitudinal projections are painted so as to have a different color from that of the majority of said longitudinal projections.

10. The slat with a wood grain appearance for a chain link fence as recited in claim 9, wherein:
said longitudinal projections have a uniform size.

11. The slat with a wood grain appearance for a chain link fence as recited in claim 10, wherein:
the space between said longitudinal projections is uniform.

12. The slat with a wood grain appearance for a chain link fence as recited in claim 10, wherein:
the space between said longitudinal projections is non-uniform.

13. The slat with a wood grain appearance for a chain link fence as recited in claim 9, wherein:
said longitudinal projections have a non-uniform size.

14. The slat with a wood grain appearance for a chain link fence as recited in claim 13, wherein:
the space between said longitudinal projections is uniform.

15. The slat with a wood grain appearance for a chain link fence as recited in claim 13, wherein:
the space between said longitudinal projections is non-uniform.

16. A slat with a wood grain appearance for a chain link fence, which comprises:
a slat having two faces, being composed of an extrudable material, and having three or more longitudinal depressions in at least one face of said slat.

17. The slat with a wood grain appearance for a chain link fence as recited in claim 16, wherein:
said longitudinal depressions have a color; and
a minority of said longitudinal depressions on each face having longitudinal depressions are coated with co-extruded material having a different color from that of the majority of said longitudinal depressions.

18. The slat with a wood grain appearance for a chain link fence as recited in claim 17, wherein:
said longitudinal depressions have a uniform size.

19. The slat with a wood grain appearance for a chain link fence as recited in claim 18, wherein:
the space between said longitudinal depressions is uniform.

20. The slat with a wood grain appearance for a chain link fence as recited in claim 18, wherein:
the space between said longitudinal depressions is non-uniform.

21. The slat with a wood grain appearance for a chain link fence as recited in claim 17, wherein:
said longitudinal depressions have a non-uniform size.

22. The slat with a wood grain appearance for a chain link fence as recited in claim 21, wherein:
the space between said longitudinal depressions is uniform.

23. The slat with a wood grain appearance for a chain link fence as recited in claim 21, wherein:
the space between said longitudinal projections is non-uniform.

24. The slat with a wood grain appearance for a chain link fence as recited in claim 16, wherein:
said longitudinal depressions have a color; and
a minority of said longitudinal depressions on each face having longitudinal depressioons are painted so as to have a different color from that of the majority of said longitudinal depressions.

25. The slat with a wood grain appearance for a chain link fence as recited in claim 24, wherein:
said longitudinal depressions have a uniform size.

26. The slat with a wood grain appearance for a chain link fence as recited in claim 25, wherein:
the space between said longitudinal depressions is uniform.

27. The slat with a wood grain appearance for a chain link fence as recited in claim 25, wherein:
the space between said longitudinal depressions is non-uniform.

28. The slat with a wood grain appearance for a chain link fence as recited in claim 24, wherein:
said longitudinal projections have a non-uniform size.

29. The slat with a wood grain appearance for a chain link fence as recited in claim 28, wherein:
the space between said longitudinal projections is uniform.

30. The slat with a wood grain appearance for a chain link fence as recited in claim 28, wherein:
the space between said longitudinal projections is non-uniform.

31. A process for forming slat with a wood grain appearance for a chain link fence, which comprises:
extruding a slat having two faces with two or more longitudinal projections on at least one face of such slat and being composed of an extrudable material having a color; and
co-extruding two or more longitudinal projections on each face having extruded longitudinal projections, but on each face having less than the number of extruded longitudinal projections on such face, such co-extruded longitudinal projections being composed of an extrudable material having a color different from the color of the extrudable material of which the slat is composed, on at least one face of said slat.

32. A process for forming slat with a wood grain appearance for a chain link fence, which comprises:
extruding a slat having two faces with three or more longitudinal projections on at least one face of such slat and being composed of an extrudable material having a color; and
painting a minority of such longitudinal projections on each face having longitudinal projections a color different from the color of the extrudable material of which the slat is composed.

33. A process for forming slat with a wood grain appearance for a chain link fence, which comprises:
extruding a slat having two faces with three or more longitudinal depressions on at least one face of such slat and being composed of an extrudable material having a color; and
coating a minority of such longitudinal depressions on each face having longitudinal depressions with co-extruded material having a color different from the color of the extrudable material of which the slat is composed.

34. A process for forming slat with a wood grain appearance for a chain link fence, which comprises:
extruding a slat having two faces with three or more longitudinal depressions on at least one face of such slat and being composed of an extrudable material having a color; and
painting a minority of such longitudinal depressions on each face having longitudinal depressions a color different from the color of the extrudable material of which the slat is composed.
